(19) United States
(12) Patent Application Publication
(10) Pub. No.: US 2014/0059201 A1
(43) Pub. Date: Feb. 27, 2014

(54) PER FLOW DYNAMIC METERING SELECTION

(71) Applicants: Fan Mo, Ottawa (CA); Richard A. Brunet, Ottawa (CA)

(72) Inventors: Fan Mo, Ottawa (CA); Richard A. Brunet, Ottawa (CA)

(73) Assignee: Alcatel-Lucent Canada, Inc., Ottawa (CA)

(21) Appl. No.: 13/591,788

(22) Filed: Aug. 22, 2012

(51) Int. Cl. G06F 15/173

(52) U.S. Cl. 709/224

(57) ABSTRACT

Various exemplary embodiments relate to a method and related network node including one or more of the following: receiving, at the PCRN, a request for establishment of a new service data flow (SDF) for a subscriber; generating a policy and charging control (PCC) rule based on the request; identifying a first metering object of a plurality of metering objects as currently applicable to the subscriber, wherein the first metering object includes a first monitoring key; and transmitting the PCC rule and the first monitoring key to the PCEN for installation. Various embodiments additionally include, after transmitting the PCC rule and the first monitoring key. identifying a second metering object of the plurality of metering objects as currently applicable to the subscriber, wherein the second metering object includes a second monitoring key; and transmitting the second monitoring key to the PCEN for installation in association with the PCC rule.

### TECHNICAL FIELD

Various exemplary embodiments disclosed herein relate generally to computer networking.

### BACKGROUND

As the demand increases for varying types of applications within mobile telecommunications networks, service providers must constantly upgrade their systems in order to reliably provide this expanded functionality. What was once a system designed simply for voice communication has grown into an all-purpose network access point, providing access to a myriad of applications including text messaging, multimedia streaming, and general Internet access. In order to support such applications, providers have built new networks on top of their existing voice networks, leading to a less-than-elegant solution. As seen in second and third generation networks, voice services must be carried over dedicated voice channels and directed toward a circuit-switched core, while other service communications are transmitted according to the Internet Protocol (IP) and directed toward a different, packet-switched core. This led to unique problems regarding application provision, metering and charging, and quality of experience (QoE) assurance.

In an effort to simplify the dual core approach of the second and third generations, the 3rd Generation Partnership Project (3GPP) has recommended a new network scheme it terms “Long Term Evolution” (LTE). In an LTE network, all communications are carried over an IP channel from user equipment (UE) to an all-IP core called the Evolved Packet Core (EPC). The EPC then provides gateway access to other networks while ensuring an acceptable QoE and charging a subscriber for their particular network activity.

The 3GPP generally describes the components of the EPC and their interactions with each other in a number of technical specifications, including the following components: Policy and Charging Rules Function (PCRF); Policy and Charging Enforcement Function (PCEF); and Bearer Binding and Event Reporting Function (BBERF) of the EPC. These technical specifications further provide some guidance as to how these elements interact in order to provide reliable data services and charge subscribers for use thereof.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method performed by a policy and charging rules node (PCRN) for providing a service via a policy and charging enforcement node (PCEN), the method including: receiving, at the PCRN, a request for establishment of a new service data flow (SDF) for a subscriber; generating a policy and charging control (PCC) rule based on the request; identifying a first metering object of a plurality of metering objects as currently applicable to the subscriber, wherein the first metering object includes a first monitoring key; and transmitting the PCC rule and the first monitoring key to the PCEN for installation.

Various exemplary embodiments relate to policy and charging rules node (PCRN) for providing a service via a policy and charging enforcement node (PCEN), the PCRN including: a metering object storage configured to store a plurality of metering objects, a first metering object of the plurality of metering objects including a first monitoring key and a first set of applicability criteria; a network interface configured to receive a request for establishment of a new service data flow (SDF) for a subscriber; a metering object module configured to identify the first metering object as currently applicable to the subscriber based on the first set of applicability criteria; a policy and charging control (PCC) rule generator configured to generate a PCC rule based on the request; and a message handler configured to transmit, via the network interface, the PCC rule and the first monitoring key to the PCEN for installation.

Various exemplary embodiments relate to non-transitory machine-readable storage medium encoded with instructions for execution by a policy and charging rules node (PCRN) for providing a service via a policy and charging enforcement node (PCEN), the medium including: instructions for receiving, at the PCRN, a request for establishment of a new service data flow (SDF) for a subscriber; instructions for generating a policy and charging control (PCC) rule based on the request; instructions for identifying a first metering object of a plurality of metering objects as currently applicable to the subscriber, wherein the first metering object includes a first monitoring key; and instructions for transmitting the PCC rule and the first monitoring key to the PCEN for installation.

Various embodiments are described wherein: the first metering object includes a set of applicability criteria, and identifying the first metering object includes determining that the set of applicability criteria is met by a set of context information associated with the subscriber.

Various embodiments are described wherein the set of applicability criteria includes at least one condition that references a value of the set of context information.

Various embodiments additionally include: receiving, at the PCRN, an update message, wherein the update message includes usage statistics for the first monitoring key; identifying an applicable threshold of the first metering object based on the usage statistics; and performing a task associated with the applicable threshold.

Various embodiments additionally include, after transmitting the PCC rule and the first monitoring key: identifying a second metering object of the plurality of metering objects as currently applicable to the subscriber, wherein the second metering object includes a second monitoring key; transmitting the second monitoring key to the PCEN for installation in association with the PCC rule.

Various embodiments additionally include receiving, by the PCRN, an update message that specifies a change to a set of context information associated with the subscriber, wherein identification of the second metering object is performed in response to receiving the update message.

Various embodiments are described wherein: the first metering object includes a first set of applicability criteria, the second metering object includes a second set of applicability criteria, identifying the first metering object includes determining that the first set of applicability criteria is met by the set of context information before receiving the update message, and identifying the second metering object includes determining that the second set of applicability criteria is met by the set of context information after receiving the update message.

Various embodiments additionally include generating an additional policy and charging control (PCC) rule based on the request; and identifying a second metering object of a plurality of metering objects as currently applicable to the subscriber, wherein the second metering object includes a second monitoring key; wherein transmitting the PCC rule and the first monitoring key to the PCEN for installation comprises transmitting the additional PCC rule and the second monitoring key to the PCEN for installation.

### BRIEF DESCRIPTION OF THE DRAWINGS

In order to better understand various exemplary embodiments, reference is made to the accompanying drawings, wherein:

FIG. 1 illustrates an exemplary network environment for providing a service;

FIG. 2 illustrates an exemplary policy and charging rules node (PCRN);

FIG. 3 illustrates an exemplary set of metering objects;

FIG. 4 illustrates an exemplary method for establishing a service; and

FIG. 5 illustrates an exemplary method for processing an update message.

To facilitate understanding, identical reference numerals have been used to designate elements having substantially the same or similar structure or substantially the same or similar function.

### DETAILED DESCRIPTION

Various services may be monitored for purposes such as charging and/or quality of service (QoS) management. For example, a network operator may wish to charge a user 2 cents per kilobyte of data transfer for a video application and may wish to downgrade service after 10 mb have been transferred. It may also be desirable to effect different charges to a service based on the context of that service or otherwise associated with the subscriber. For example, a network operator may wish to apply different charging metrics for a service when the subscriber is roaming compared to when the subscriber is not roaming. Implementation of such functionality may involve the definition of multiple monitoring schemes that may be applicable under the different contexts. During the lifetime of a service data flow (SDF), however, the context may change, warranting the imposition of a different monitoring scheme. Handling of such a contingency may involve completely reprovisioning an SDF, which may be unnecessarily taxing on available system resources and may be prone to error. Accordingly, there exists a need for a system and method for providing and modifying services without complete reprovisioning.

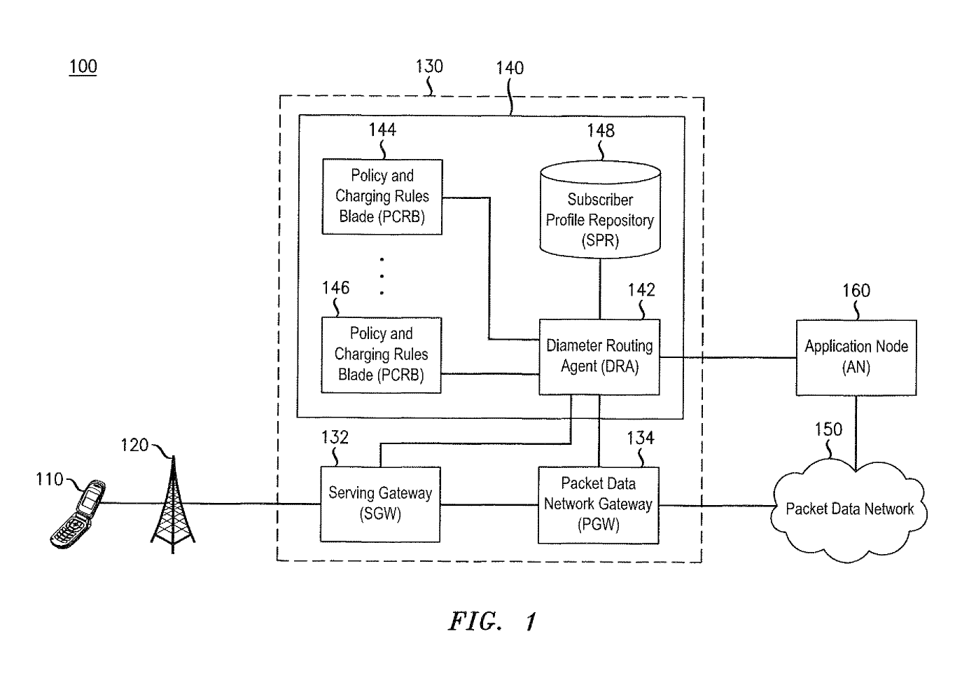

FIG. 1 illustrates an exemplary network environment 100 for providing a service. The exemplary network environment 100 may be a subscriber network for providing various services. In various embodiments, the subscriber network 100 may be a public land mobile network (PLMN). The subscriber network 100 may be a telecommunications network or other network for providing access to various services. The subscriber network 100 may include user equipment 110, a base station 120, an evolved packet core (EPC) 130, a packet data network 150, and an application node (AN) 160.

The user equipment 110 may be a device that communicates with the packet data network 150 for providing the end-user with a data service. Such data service may include, for example, voice communication, text messaging, multimedia streaming, and/or Internet access. More specifically, in various exemplary embodiments, the user equipment 110 is a personal or laptop computer, wireless email device, cell phone, tablet, television set-top box, or any other device capable of communicating with other devices via the EPC 130.

The base station 120 may be a device that enables communication between the user equipment 110 and the EPC 130. For example, the base station 120 may be a base transceiver station such as an evolved nodeB (eNodeB) as defined by the relevant 3GPP standards. Thus, the base station 120 may be a device that communicates with the user equipment 110 via a first medium, such as radio waves, and communicates with the EPC 130 via a second medium, such as Ethernet cable. The base station 120 may be in direct communication with the EPC 130 or may communicate via a number of intermediate nodes (not shown). In various embodiments, multiple base stations (not shown) may be present to provide mobility to the user equipment 110. Note that in various alternative embodiments, the user equipment 110 may communicate directly with the EPC 130. In such embodiments, the base station 120 may not be present.

The evolved packet core (EPC) 130 may be a device or network of devices that provides the user equipment 110 with gateway access to the packet data network 140. The EPC 130 may further charge a subscriber for use of provided data services and ensure that particular quality of experience (QoE) standards are met. Thus, the EPC 130 may be implemented, at least in part, according to the relevant 3GPP standards. The EPC 130 may include a serving gateway (SGW) 132, a packet data network gateway (PGW) 134, and a session control device 140.

The serving gateway (SGW) 132 may be a device that provides gateway access to the EPC 130. The SGW 132 may be one of the first devices within the EPC 130 that receives packets sent by the user equipment 110. Various embodiments may also include a mobility management entity (MME) (not shown) that receives packets prior to the SGW 132. The SGW 132 may forward such packets toward the PGW 134. The SGW 132 may perform a number of functions such as, for example, managing mobility of the user equipment 110 between multiple base stations (not shown) and enforcing particular quality of service (QoS) characteristics for each flow being served. In various implementations, such as those implementing the Proxy Mobile IP standard, the SGW 132 may include a Bearer Binding and Event Reporting Function (BBERF). In various exemplary embodiments, the EPC 130 may include multiple SGWs (not shown) and each SGW may communicate with multiple base stations (not shown).

The packet data network gateway (PGW) 134 may be a device that provides gateway access to the packet data network 140. The PGW 134 may be the final device within the EPC 130 that receives packets sent by the user equipment 110 toward the packet data network 140 via the SGW 132. The PGW 134 may include a policy and charging enforcement function (PCEF) that enforces policy and charging control (PCC) rules for each service data flow (SDF). Therefore, the PGW 134 may be a policy and charging enforcement node (PCEN). The PGW 134 may include a number of additional features such as, for example, packet filtering, deep packet inspection, and subscriber charging support. The PGW 134 may also be responsible for requesting resource allocation for unknown application services.

The session control device 140 may be a device that provides various management or other functions within the EPC 130. For example, the session control device 140 may provide a Policy and Charging Rules Function (PCRF) and, as such, may constitute a Policy and Charging Rules Node (PCRN). In various embodiments, the session control device 140 may include an Alcatel Lucent 5780 Dynamic Services Controller (DSC). The session control device 140 may include a Diameter routing agent (DRA) 142, a plurality of policy and charging rules blades (PCRBs) 144, 146, and a subscriber profile repository 148.

The DRA 142 may be an intelligent Diameter routing agent. As such, the DRA 142 may operate as a relay agent, proxy agent, and/or redirect agent for various receive messages. Such routing may be performed with respect to incoming and outgoing messages, as well as messages that are internal to the session control device. For example, the DRA 142 may receive a message from the PGW 134 and forward the request to an appropriate PCRB 144, 146.

The policy and charging rules blades (PCRBs) 144, 146 may each be a device or group of devices that receives requests for application services, generates PCC rules, and/or provides PCC rules to the PGW 134 or other PCENs (not shown). The PCRBs 144, 146 may each implement a PCRF and, as such, may each independently constitute a PCRN. Thus, the session control device 140 and each of the PCRBs 144, 146 may constitute PCRNs. The PCRBs 144, 146 may be in communication with AN 160 according to an Rx Diameter application via the DRA 142. As described in further detail below with respect to the AN 160, the PCRBs 144, 146 may receive an application request in the form of an Authentication and Authorization Request (AAR) from the AN 160. Upon receipt of an AAR, the PCRB 144, 146 may generate at least one new PCC rule for fulfilling the application request.

The PCRBs 144, 146 may also be in communication with the SGW 132 and the PGW 134 according to a Gxx and a Gx Diameter application, respectively, via the DRA 142. A PCRB 144, 146 may receive an application request in the form of a credit control request (CCR) from the SGW 132 or the PGW 134. As with an AAR, upon receipt of a CCR, the PCRBs 144, 146 may generate at least one new PCC rule for fulfilling the application request. In various embodiments, the AAR and the CCR may represent two independent application requests to be processed separately, while in other embodiments, the AAR and the CCR may carry information regarding a single application request and the PCRB 144, 146 may create at least one PCC rule based on the combination of the AAR and the CCR. In various embodiments, the PCRBs 144, 146 may be capable of handling both single-message and paired-message application requests.

Upon creating a new PCC rule or upon request by the PGW 134, a PCRB 144, 146 may provide a PCC rule to the PGW 134 according to the Gx application. In various embodiments, such as those implementing the proxy mobile IP (PMIP) standard for example, the PCRB 144, 146 may also generate QoS rules. Upon creating a new QoS rule or upon request by the SGW 132, the PCRB 144, 146 may provide a QoS rule to SGW 132 according to the Gxx application.

The subscriber profile repository (SPR) 148 may be a device that stores information related to subscribers to the subscriber network 100. Thus, the SPR 148 may include a machine-readable storage medium such as read-only memory (ROM), random-access memory (RAM), magnetic disk storage media, optical storage media, flash-memory devices, and/or similar storage media. The SPR 148 may be a component of one or more of the PCRBs 144, 146 or may constitute an independent node within the EPC 130 or the session control device 140. Data stored by the SPR 138 may include subscriber information such as identifiers for each subscriber, bandwidth limits, charging parameters, and subscriber priority.

The packet data network 150 may be any network for providing data communications between the user equipment 110 and other devices connected to the packet data network 150, such as the AN 160. The packet data network 150 may further provide, for example, phone or Internet service to various user devices in communication with packet data network 150. In various embodiments, the packet data network 150 may include the Internet.

The application node (AN) 160 may be a device that provides a known application service to the user equipment 110. Thus, the AN 160 may be a server or other device that provides, for example, a video streaming or voice communication service to the user equipment 110. The AN 160 may further be in communication with the PCRBs 144, 146 of the EPC 130 according to the Rx application. When the AN 160 is to begin providing known application service to the user equipment 110, the AN 160 may generate an application request message, such as an authentication and authorization request (AAR) according to the Diameter protocol, to notify a PCRB 144, 146 that resources should be allocated for the application service. This application request message may include information such as an identification of the subscriber using the application service, an IP address of the subscriber, an APN for an associated IP-CAN session, or an identification of the particular service data flows that must be established in order to provide the requested service.

As will be understood, various Diameter applications may be established within the subscriber network 100 and supported by the DRA 142. For example, an Rx application may be established between the AN 160 and each of PCRBs 144, 146. As another example, an Sp application may be established between the SPR 148 and each of PCRBs 144, 146. As yet another example, an S9 application may be established between one or more of the PCRBs 144, 146 and a remote device implementing another PCRF (not shown). As will be understood, numerous other Diameter applications may be established within the subscriber network 100.

As will be described in greater detail below, in establishing various service data flows (SDFs), the PCRBs 144, 146 may be adapted to utilize a metering object. Upon receiving a request, a PCRB 144, 146 may identify an applicable metering object based on the requesting subscriber and the context of the request. The metering object may specify a monitoring key to be used while the metering object is applicable for the SDF to be established. Separately, the PCRB 144, 146 may also generate a PCC rule for installation at the PGW 134 for establishing the SDF. Thus, the logic used for generating the PCC rule need not consider the selection of a monitoring key, because the monitoring key may be selected based on the applicable metering object. Further as time goes on, other metering objects may become applicable to the SDF. In such a case, the PCRN 144, 146 may be adapted to install any new monitoring keys without regenerating and/or reinstalling the PCC rule. In various alternative embodiments, the PCRN 144, 146 may update the PCC rule to create an association between the PCC rule and the new monitoring keys.

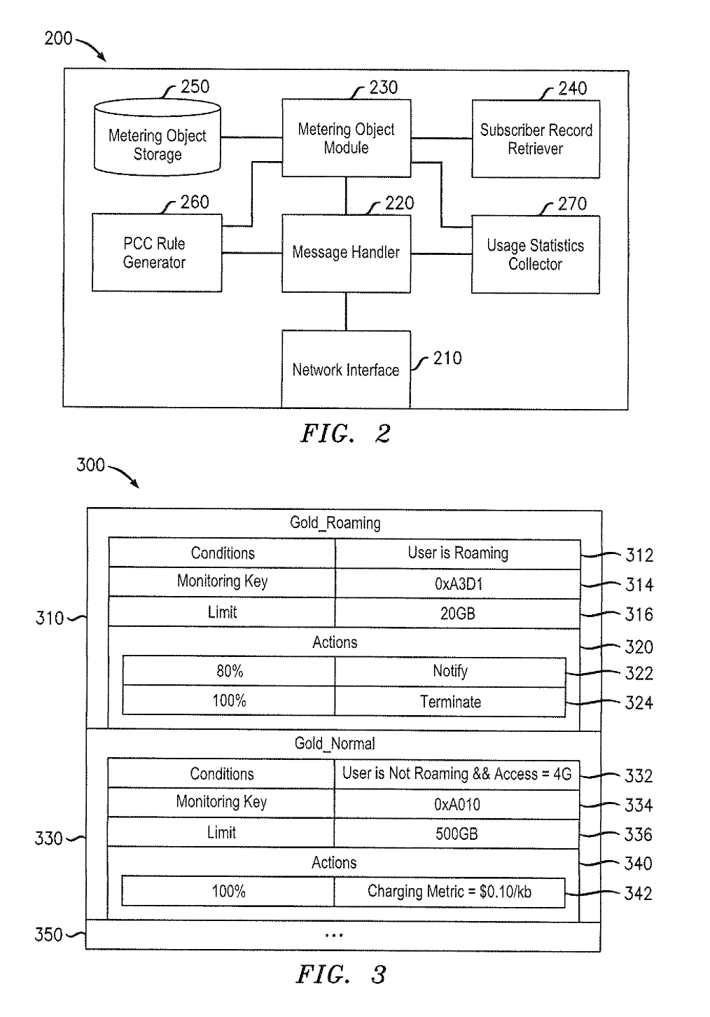

FIG. 2 illustrates an exemplary policy and charging rules node (PCRN) 200. The PCRN 200 may be a standalone device or a component of a larger system. For example, the PCRN 200 may correspond to one or more of the PCRBs 144, 146 of the subscriber network 100. The PCRN 200 may include a network interface 210, a message handler 220, a metering object module 230, a subscriber record retriever 240, a metering object storage 250, a PCC rule generator 260, and a usage statistics collector 270. It will be apparent that various components of the PCRN 200 may constitute abstractions and may utilize other hardware devices. For example, the components may utilize one or more common processors. As used herein, the term “processor” will be understood to encompass microprocessors, field-programmable gate arrays (FPGAs), application-specific integrated circuits (ASICs), and/or other similar hardware devices.

The network interface 210 may include an interface including hardware or executable instructions encoded on a machine-readable storage medium configured to communicate with other devices. For example, the network interface 210 may include an Ethernet or TCP/IP interface. In various embodiments, the network interface 210 may include multiple physical ports. The network interface 210 may also implement a Diameter stack.

The message handler 220 may include hardware and/or executable instructions encoded on a machine-readable medium configured to receive, process, and transmit various Diameter messages via the network interface 210. For example, the message handler 220 may be configured to receive and identify a message requesting the establishment of a new service. In processing the establishment request, the message handler 220 may instruct the metering object module 230 to retrieve and evaluate a metering object to return a monitoring key to be installed at an appropriate PCEN. The message handler 220 may also instruct the PCC rule generator 260 to generate one or more rules for installation at the PCEN for establishing the service. After processing the establishment message, the message handler 220 may construct and transmit, via the network interface 210, a message to install the PCC rule and monitoring key. For example, the message handler 220 may transmit a CCA installing the PCC rule and monitoring key at the PCEN.

The metering object module 230 may include hardware and/or executable instructions encoded on a machine-readable medium configured to retrieve and evaluate a metering object. Each subscriber may be associated with a set of potentially applicable metering objects. For example, a network operator may specify, in each subscriber record, what metering objects could be applicable for the subscriber. To determine which subset of metering objects stored in the metering object storage 250 could possibly apply, the metering object module 230 may request a subscriber record from the subscriber record retriever 240. After receiving the subscriber record and determining which subset of metering objects may apply, the metering object module 230 may proceed to determine which metering object of the subset actually applies to the current context.

Each metering object may include one or more conditions for determining whether the metering object applies to a current context. The metering object module 230 may evaluate these conditions and select one metering object to be further evaluated. Each metering object may further include a monitoring key and a number of actions associated with usage thresholds. Each action may specify one or more tasks to be performed with respect to a service such as, for example, transmission of a notification or termination of service. The metering object module 230 may select an appropriate action and pass the action, if any, back to the message handler 220 for performance of the specified tasks. The metering object module 230 may also pass the monitoring key back to the message handler 220.

The subscriber record retriever 240 may include hardware and/or executable instructions encoded on a machine-readable medium configured to retrieve a subscriber record from an SPR (not shown). Thus, the subscriber record retriever 240 may receive one or more subscriber identifiers from the metering object module 230 identifying the subscriber record to be retrieved. The subscriber record retriever 240 may then communicate with an SPR according to the Sp application to retrieve the record for use by the metering object module 230.

The metering object storage 250 may be any machine-readable medium capable of storing one or more metering objects. Accordingly, the metering object storage 250 may include a machine-readable storage medium such as read-only memory (ROM), random-access memory (RAM), magnetic disk storage media, optical storage media, flash-memory devices, and/or similar storage media. Exemplary contents for the metering object storage 250 will be described in greater detail below with respect to FIG. 3.

The PCC rule generator 260 may include hardware and/or executable instructions encoded on a machine-readable medium configured to generate one or more dynamic PCC rules at the request of the message handler 220. Such rules may be generated based on a subscriber profile, context information, and/or the request itself. In various embodiments, the PCC rule generator 260 may include a rule engine configured to analyze a plurality of operator-provisioned rules. These rules may be applied to construct a new PCC rule for installation at the PCEN. As noted above, these operator-provisioned rules need not select a monitoring key because the monitoring key may be specified separately by the applicable metering object. As such, the creation of the operator-provisioned rules may be simplified for the network operator.

At various times, PCENs may also transmit update messages for existing services. The message handler 220 may be further configured to process update messages. An update message may specify changed service conditions that may warrant reevaluation of a monitoring object. For example, an update message may indicate that a user device is now roaming, in which case a network operator may wish to utilize a different monitoring key. Upon receiving such an update message, the message handler 220 may instruct the metering object module 230 to select and evaluate a metering object, as previously described. The update message may alter context information associated with the service and may lead to the selection and evaluation of a different monitoring object than previously selected for the service. When performing actions associated with a newly-applicable monitoring object, the message handler 220 may be configured to “roll back” any actions performed based on the previous monitoring object. For example, the message handler may uninstall a previously-installed monitoring key.

Some update messages may include usage statistics. Upon receiving an update including usage statistics, the message handler 220 may be configured to forward the monitoring key and usage statistics to the usage statistics collector 270.

The usage statistics collector 270 may include hardware and/or executable instructions encoded on a machine-readable medium configured to store usage statistics for use by the metering object module 230. As such, the usage statistics collector 270 may include a machine-readable storage medium configured to store usage statistics in association with a service and/or monitoring key. The metering object module 230 may access these usage statistics when evaluating a monitoring object. Based on the usage statistics, the metering object module 230 may determine that one or more usage thresholds have been met and that the associated action should be performed by the message handler.

FIG. 3 illustrates an exemplary set of metering objects 300. The set of metering objects 300 may be stored, for example, in the metering object storage 250 of the exemplary PCRN 200. The set of metering objects 300 may be stored as, for example, a table in a database stored in the metering object storage 250. Alternatively, the set of metering objects 300 could be a series of linked lists, an array, or a similar data structure. Thus, it should be apparent that the set of metering objects 300 may be an abstraction of the underlying data; any data structure suitable for storage of this data may be used.

The set of metering objects 300 may include a number of metering objects 310, 330, 350. As shown in exemplary metering object 310, each metering object may include a set of conditions 312 for determining whether a metering object applies to a current context. For example, the set of conditions 312 may indicate that metering object 310 may be applicable when a user is roaming. Thus, the set of conditions 312 may be referred to as “applicability criteria.” Each metering object 310, 330, 350 may also specify a monitoring key that the PCEN should use in monitoring and reporting data usage for a service. For example, monitoring object 310 may include a monitoring key field 314 that indicates that the monitoring key “0xA3D1” should be used for monitoring purposes. The metering objects 310, 330, 350 may also include a usage limit specifying the total amount of data transfer that may be accumulated under the monitoring key. As shown in the example, monitoring object 310 may include a limit field 316 specifying a usage limit of 20 gigabytes.

As further illustrated by exemplary monitoring object 310, each monitoring object may also include a set of actions 320 specifying tasks to be performed at different usage thresholds. For example, the set of actions 320 may include an action 322 indicating that once reported usage amounts to at least 80% of the 20 GB limit, the subscriber should be notified such as, for example, via a text message. The set of actions 320 may also specify that, when the usage threshold has been met, the service should be terminated. It will be understood that each action may specify multiple tasks to be performed. For example, an action (not shown) may specify that a subscriber should be notified and that a predefined or provisioned PCC rule should be installed along with, or in place of, any previously installed dynamic PCC rules for the service.

As another example, monitoring object 330 may include a conditions field 332 specifying applicability when a user is not roaming and when connected to a 4G network. Thus, as shown, a conditions field may include multiple conditions and logical operators such as “AND,” “OR,” and “NOT.” Monitoring object 330 may also include a monitoring key field 334 specifying that monitoring key “0xA010” should be used when the monitoring object 330 is active and a limit field 336 specifying a usage limit of 500 gigabytes. The set of actions 340 may specify that once the usage limit has been met, a charging metric of 10 cents per kilobyte should be enforced. Thus, as illustrated, monitoring object 310, 330, 350 may allow usage to surpass the specified usage limit.

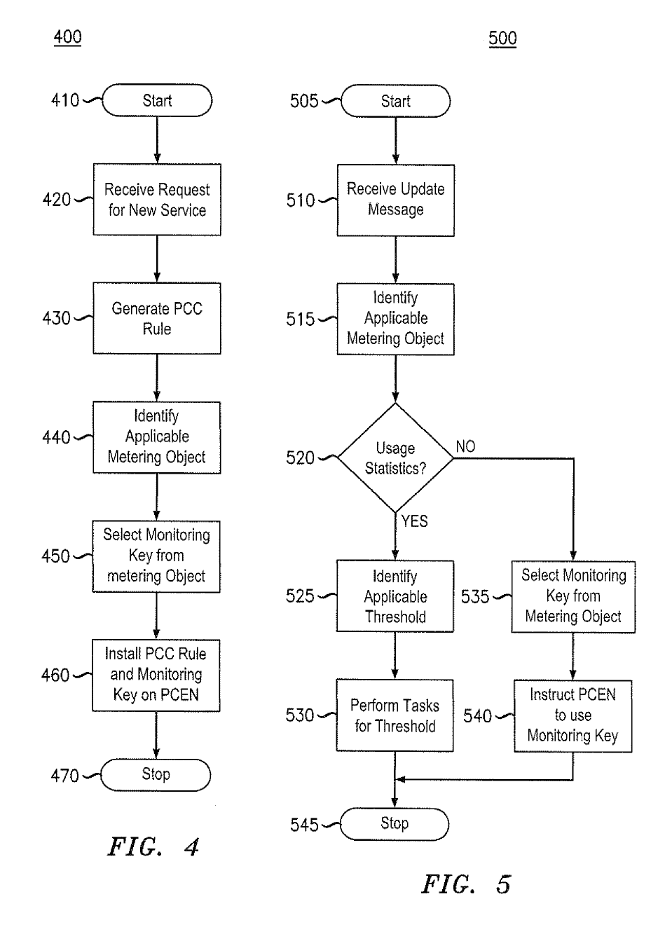

FIG. 4 illustrates an exemplary method 400 for establishing a service. The method 400 may be performed by the components of a PCRN such as, for example, the message handler 220, the metering object module 230, and the PCC rule generator 260 of the exemplary PCRN 200.

The method 400 may begin in step 410 and proceed to step 420 where the PCRN 200 may receive a request for a new service. For example, the PCRN 200 may receive a CCR from a PGW and/or an AAR from an AN requesting the establishment of one or more SDFs. Next, in step 430, the PCRN 200 may generate one or more PCC rules for establishing the requested service. In generating PCC rules, the PCRN 200 may apply operator-provided rules to dynamically generate PCC rules. The operator-provided rules may reference the request message and/or the subscriber profile to make decisions regarding values to be included in the PCC rule.

After generation of the PCC rule, the PCRN 200, in step 440, may identify an applicable metering object. For example, the PCRN 200 may first retrieve a subscriber record to identify which metering objects might apply. Next, the PCRN 200 may evaluate conditions associated with the identified metering objects to select one applicable metering object. The PCRN 200 may then, in step 450, select a monitoring key from the metering object. In embodiments wherein the metering object includes a single monitoring key, the PCRN 200 may simply identify the monitoring key included in the applicable metering object. Finally, the PORN may, in step 460, install both the PCC rule and monitoring key on the appropriate PCEN. Such installation may include transmitting the PCC rule and monitoring key in a CCA or RAR message. The installation may also include linking or otherwise storing an association between the PCC rule and monitoring key. Method 400 may then proceed to end in step 470.

Various alternative embodiments may implement method 400 in a different order. For example, steps 440, 450 may be performed prior to step 430. As another example, step 430 may be performed in parallel with steps 440, 450. Various additional modifications will also be apparent.

FIG. 5 illustrates an exemplary method 500 for processing an update message. The method 500 may be performed by the components of a PCRN such as, for example, the message handler 220, the metering object module 230, and the usage statistics collector 270 of the exemplary PCRN 200.

The method 500 may begin in step 505 and proceed to step 510 where the PCRN may receive an update message. The update message may be a CCR, AAR, or other Diameter message that provides information regarding a subscriber, and IP-CAN session, a bearer, and/or an SDF. For example, an update message may include a monitored usage report for a monitoring key. An update message, additionally or alternatively, may include information that alters a current context for a service and/or subscriber. For example, the update message may indicate that the subscriber has moved and is now connected to a different network. As a result, the subscriber's roaming status and/or connection technology may have changed. Various other changes to context information that may be carried by an update message will be apparent to those of skill in the art.

Based upon receipt of the update message, the PCRN 200 may, in step 515, identify a metering object applicable to the impacted session. This step may be similar to step 440 of method 400, described above. Next, in step 520, the PCRN 200 may determine whether the update message includes a report of usage statistics. If so, the method 500 may proceed to step 525 where the PCRN 200 may identify any applicable threshold of the metering object. Such identification may involve comparing the reported usage to the usage limit and/or one or more thresholds specified by the metering object. If a threshold has been crossed, the PCRN 200 may identify that threshold as being applicable. In various embodiments, the PCRN 200 may only identify the highest crossed threshold or only those thresholds crossed since the last evaluation of the metering object as being applicable. The PCRN 200 may then perform any tasks associated with the applicable threshold(s) in step 530. In various embodiments, the PCRN 200 may perform tasks associated with multiple thresholds. For example, the PCRN 200 may install a key associated with a “20%” threshold and a key associated with a “30%” threshold when both thresholds have been met. It will also be understood that multiple PCC rules may be created to establish multiple flows based on one request. Under such conditions, the PCRN 200 may select different metering objects and therefore different monitoring keys for each such PCC rule and flow. The method 500 may then proceed to end in step 545.

If, on the other hand, the PCRN 200 determines in step 520 that the update message does not include a usage statistics report, the method 500 may proceed to step 535. In step 535, the PCRN 200 may select a monitoring key from the applicable metering object. This selection may be performed in a manner similar to that of step 450, described above with regard to method 400, but may result in the selection of a different monitoring object based on changes to the current context effected by, for example, the update message. After selecting a monitoring key, the PCRN 200 may, in step 540, instruct the PCEN to use the monitoring key in gathering usage statistics. Where the monitoring key is not currently being used by the PCEN, the PCRN 200 may transmit the monitoring key to the PCEN for installation. Where the monitoring key has already been installed for the SDF, such as when the applicable metering object has not changed since the last evaluation, the PCRN 200 may simply refrain from uninstalling the monitoring key. The method 500 may then proceed to end in step 545.

According to the foregoing, various embodiments enable the efficient and reliable establishment and updating of services to utilize different monitoring keys. By providing flow-level metering objects with applicability criteria, the selection of a monitoring key may be performed independently of the generation of PCC rules for defining a requested flow. After selection of a monitoring key, the monitoring key may be inserted into the PCC rule prior to installation. As such, the logic for creating PCC rules may be simplified and need not be reevaluated when a context change warrants use of a different monitoring key. Additional benefits will be apparent in view of the foregoing.

It should be apparent from the foregoing description that various exemplary embodiments of the invention may be implemented in hardware or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a tangible and non-transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method performed by a policy and charging rules node (PCRN) for providing a service via a policy and charging enforcement node (PCEN), the method comprising:
receiving, at the PCRN, a request for establishment of a new service data flow (SDF) for a subscriber;
generating a policy and charging control (PCC) rule based on the request;
identifying a first metering object of a plurality of metering objects as currently applicable to the subscriber, wherein the first metering object includes a first monitoring key; and
transmitting the PCC rule and the first monitoring key to the PCEN for installation.

2. The method of claim 1, wherein:
the first metering object includes a set of applicability criteria, and
identifying the first metering object comprises determining that the set of applicability criteria is met by a set of context information associated with the subscriber.

3. The method of claim 2, wherein the set of applicability criteria includes at least one condition that references a value of the set of context information.

4. The method of claim 1, further comprising:
receiving, at the PCRN, an update message, wherein the update message includes usage statistics for the first monitoring key;
identifying an applicable threshold of the first metering object based on the usage statistics; and
performing a task associated with the applicable threshold.

5. The method of claim 1, further comprising, after transmitting the PCC rule and the first monitoring key:
identifying a second metering object of the plurality of metering objects as currently applicable to the subscriber, wherein the second metering object includes a second monitoring key;
transmitting the second monitoring key to the PCEN for installation in association with the PCC rule.

6. The method of claim 5, further comprising receiving, by the PCRN, an update message that specifies a change to a set of context information associated with the subscriber,
wherein identification of the second metering object is performed in response to receiving the update message.

7. The method of claim 6, wherein:
the first metering object includes a first set of applicability criteria,
the second metering object includes a second set of applicability criteria,
identifying the first metering object comprises determining that the first set of applicability criteria is met by the set of context information before receiving the update message, and
identifying the second metering object comprises determining that the second set of applicability criteria is met by the set of context information after receiving the update message.

8. The method of claim 1, further comprising:
generating an additional policy and charging control (PCC) rule based on the request; and
identifying a second metering object of a plurality of metering objects as currently applicable to the subscriber, wherein the second metering object includes a second monitoring key;
wherein transmitting the PCC rule and the first monitoring key to the PCEN for installation comprises transmitting the additional PCC rule and the second monitoring key to the PCEN for installation.

9. A policy and charging rules node (PCRN) for providing a service via a policy and charging enforcement node (PCEN), the PCRN comprising:
a metering object storage configured to store a plurality of metering objects, a first metering object of the plurality of metering objects including a first monitoring key and a first set of applicability criteria;
a network interface configured to receive a request for establishment of a new service data flow (SDF) for a subscriber;
a metering object module configured to identify the first metering object as currently applicable to the subscriber based on the first set of applicability criteria;
a policy and charging control (PCC) rule generator configured to generate a PCC rule based on the request; and
a message handler configured to transmit, via the network interface, the PCC rule and the first monitoring key to the PCEN for installation.

10. The PCRN of claim 9, wherein the first set of applicability criteria includes at least one condition that references a value of a set of context information associated with the subscriber.

11. The PCRN of claim 9, wherein:
the network interface is further configured to receive an update message, wherein the update message includes usage statistics for the first monitoring key;
the metering object module is further configured to identify an applicable threshold of the first metering object based on the usage statistics; and
the message handler is further configured to perform a task associated with the applicable threshold.

12. The PCRN of claim 9, wherein:
the metering object module is further configured to, after the message handler transmits the PCC rule and the first monitoring key, identify a second metering object of the plurality of metering objects as currently applicable to the subscriber, wherein the second metering object includes a second monitoring key; and
the message handler is further configured to transmit the second monitoring key to the PCEN for installation in association with the PCC rule.

13. The PCRN of claim 12, wherein:
the network interface is further configured to receive an update message that specifies a change to a set of context information associated with the subscriber, and
in identifying the second metering object, the metering object module is configured to identify the second metering object in response to the network interface receiving the update message.

14. The PCRN of claim 13, wherein:
the second metering object includes a second set of applicability criteria,
in identifying the first metering object, the metering object module is configured to determine that the first set of applicability criteria is met by the set of context information before receiving the update message, and
in identifying the second metering object, the metering object module is configured to determine that the second set of applicability criteria is met by the set of context information after receiving the update message.

15. A non-transitory machine-readable storage medium encoded with instructions for execution by a policy and charging rules node (PCRN) for providing a service via a policy and charging enforcement node (PCEN), the medium comprising:
instructions for receiving, at the PCRN, a request for establishment of a new service data flow (SDF) for a subscriber;
instructions for generating a policy and charging control (PCC) rule based on the request;
instructions for identifying a first metering object of a plurality of metering objects as currently applicable to the subscriber, wherein the first metering object includes a first monitoring key; and
instructions for transmitting the PCC rule and the first monitoring key to the PCEN for installation.

16. The non-transitory machine-readable storage medium of claim 15, wherein:
the first metering object includes a set of applicability criteria, and
the instructions for identifying the first metering object comprise instructions for determining that the set of applicability criteria is met by a set of context information associated with the subscriber.

17. The non-transitory machine-readable storage medium of claim 16, wherein the set of applicability criteria includes at least one condition that references a value of the set of context information.

18. The non-transitory machine-readable storage medium of claim 15, further comprising:
instructions for receiving, at the PCRN, an update message, wherein the update message includes usage statistics for the first monitoring key;
instructions for identifying an applicable threshold of the first metering object based on the usage statistics; and
instructions for performing a task associated with the applicable threshold.

19. The non-transitory machine-readable storage medium of claim 15, further comprising instructions for, after transmitting the PCC rule and the first monitoring key:
identifying a second metering object of the plurality of metering objects as currently applicable to the subscriber, wherein the second metering object includes a second monitoring key;
transmitting the second monitoring key to the PCEN for installation in association with the PCC rule.

20. The non-transitory machine-readable storage medium of claim 19, further comprising instructions for receiving, by the PCRN, an update message that specifies a change to a set of context information associated with the subscriber,
wherein the instructions for identification of the second metering object are configured to be executed in response to receiving the update message.
